(19) United States
(12) Patent Application Publication
(10) Pub. No.: US 2025/0342028 A1
(43) Pub. Date: Nov. 6, 2025

(54) REFUSE VEHICLE WITH CONTROLLER AREA NETWORK AND OVER THE AIR PROGRAMMING

(71) Applicant: Oshkosh Corporation, Oshkosh, WI (US)

(72) Inventors: Quincy Wittman, Oshkosh, WI (US); Andrew Cornelius, Oshkosh, WI (US); William Young, Oshkosh, WI (US); Zhenyi Wei, Oshkosh, WI (US); Robby Lance, Oshkosh, WI (US); John Kasper, Oshkosh, WI (US); Rainu Pierce, Oshkosh, WI (US); Nicholas Weykamp, Oshkosh, WI (US); Vince Schad, Oshkosh, WI (US)

(73) Assignee: Oshkosh Corporation, Oshkosh, WI (US)

(21) Appl. No.: 19/197,777

(22) Filed: May 2, 2025

Related U.S. Application Data
(60) Provisional application No. 63/642,181, filed on May 3, 2024.

(51) Int. Cl. G06F 8/65; B60R 16/023; B65F 3/02; B65F 3/04; G07C 5/00; G07C 5/08

(52) U.S. Cl. CPC G06F 8/65; B60R 16/0231; B65F 3/041; G07C 5/008; G07C 5/085; B65F 2003/0269; B65F 2003/0283

(57) ABSTRACT

A system includes a refuse vehicle. The refuse vehicle includes a vehicle system and a first controller. The vehicle system performs one or more operations of the refuse vehicle. The first controller includes one or more processing circuits. The one or more processing circuits receive a plurality of updates associated with the vehicle system or the one or more operations of the refuse vehicle and transmit the plurality of updates to a second controller that controls performance of the one or more operations.

### CROSS-REFERENCE TO RELATED PATENT APPLICATIONS

This application claims the benefit of and priority to U.S. Provisional Patent Application No. 63/642,181, filed May 3, 2024, the entirety of which is incorporated by reference herein.

### BACKGROUND

Refuse vehicles can include one or more components to perform one or more operations.

### SUMMARY

At least one embodiment relates to a system. The system can include a server. The server can store information associated with a refuse vehicle. The system can include a network. The system can include the refuse vehicle. The refuse vehicle can include a vehicle system. The vehicle system can perform one or more operations of the refuse vehicle. The vehicle system can be controlled by a secondary controller. The refuse vehicle can include a first controller. The first controller can include one or more processing circuits. The one or more processing circuits can receive, from the server via the network, a plurality of updates associated with the vehicle system or the one or more operations of the refuse vehicle. The one or more processing circuits can transmit, via a controller area network (CAN) bus, the plurality of updates to the secondary controller.

At least one embodiment relates to a refuse vehicle. The refuse vehicle can a vehicle system. The vehicle system can perform one or more operations of the refuse vehicle. The vehicle system can be controlled by a secondary controller. The refuse vehicle can include a first controller. The first controller can include one or more processing circuits. The one or more processing circuits can receive, from a server via a network, a plurality of updates associated with the vehicle system or the one or more operations of the refuse vehicle. The one or more processing circuits can transmit, via a controller area network (CAN) bus, the plurality of updates to the secondary controller.

At least one embodiment relates to a refuse vehicle. The refuse vehicle can include a first vehicle system. The first vehicle system can perform one or more first operations of the refuse vehicle. The first vehicle system can be controllable by a first controller. The refuse vehicle can include a second vehicle system. The second vehicle system can perform one or more second operations of the refuse vehicle. The second vehicle system can be controllable by a second controller. The refuse vehicle can include a third controller. The third controller can include one or more processing circuits. The one or more processing circuits can receive, from a server via a network, a plurality of updates associated with at least one of the first vehicle system, the second vehicle system, the one or more first operations, or the one or more second operations. The one or more processing circuits can transmit the plurality of updates via a Controller Area Network (CAN) bus.

At least one embodiment relates to a refuse vehicle. The refuse vehicle can include a first vehicle system. The first vehicle system can perform one or more first operations of the refuse vehicle. The first vehicle system can be controllable by a first controller. The refuse vehicle can include a second vehicle system. The second vehicle system can perform one or more second operations of the refuse vehicle. The second vehicle system can be controllable by a second controller. The refuse vehicle can include a third controller. The third controller can include one or more processing circuits. The one or more processing circuits can receive, during operation of the refuse vehicle, from a server via a network, a plurality of updates associated with at least one of the first vehicle system, the second vehicle system, the one or more first operations, or the one or more second operations. The one or more processing circuits can determine, based on information included with at least one update of the plurality of updates, that the at least one update corresponds to the second vehicle system. The one or more processing circuits can transmit, during the operation of the refuse vehicle, via a Controller Area Network (CAN) bus, the at least one update to the second controller based on a status of the second vehicle system.

At least one embodiment relates to a system. The system can include a first controller. The first controller can control a first vehicle system of a refuse vehicle. The first vehicle system can perform one or more first operations of the refuse vehicle. The system can include a second controller. The second controller can control a second vehicle system of the refuse vehicle. The second vehicle system can perform one or more second operations of the refuse vehicle. The system can include a third controller. The third controller can include one or more processing circuits. The one or more processing circuits can receive, from a server via a network, a plurality of updates associated with at least one of the first vehicle system, the second vehicle system, the one or more first operations, or the one or more second operations. The one or more processing circuits can transmit the plurality of updates via a Controller Area Network (CAN) bus.

At least one embodiment relates to a system. The system can include a first controller. The first controller can control a first vehicle system of a refuse vehicle. The first vehicle system can perform one or more first operations of the refuse vehicle. The system can include a second controller. The second controller can control a second vehicle system of the refuse vehicle. The second vehicle system can perform one or more second operations of the refuse vehicle. The system can include a third controller. The third controller can include one or more processing circuits. The one or more processing circuits can receive, from a server via a network, a plurality of updates associated with at least one of the first vehicle system, the second vehicle system, the one or more first operations, or the one or more second operations. The one or more processing circuits can detect, responsive to receipt of the plurality of updates, a performance of the one or more first operations. The one or more processing circuits can prevent, responsive to detection of the performance of the one or more first operations, a transmission of at least one first update of the plurality of updates to the first controller to maintain operation of the first controller. The one or more processing circuits can transmit, to the second controller via a Controller Area Network (CAN) bus, at least one second update of the plurality of updates based on the second vehicle system being in an idle state.

At least one embodiment relates to a system. The system can include a refuse vehicle. The refuse vehicle can include a vehicle system. The vehicle system can perform one or more operations of the refuse vehicle. The refuse vehicle can include a first controller. The first controller can include one or more processing circuits. The one or more processing circuits can receive, from a server via a network, a plurality of updates associated with the vehicle system or the one or more operations of the refuse vehicle. The one or more processing circuits can transmit, via a controller area network (CAN) bus, the plurality of updates to a second controller configured to control performance of the one or more operations.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a front-loading refuse vehicle, according to an exemplary embodiment.

FIG. 2 is a perspective view of a side-loading refuse vehicle, according to an exemplary embodiment.

FIG. 3 is a perspective view of a zero-radius side-loading refuse vehicle, according to an exemplary embodiment.

FIG. 4 is a perspective view of a body of the refuse vehicle of FIG. 3, according to an exemplary embodiment.

FIG. 5 is a block diagram of a system to provide over-the-air (OTA) updates and telematic information via one or more networks, according to an exemplary embodiment.

FIG. 6 is an illustration of a Controller Area Network (CAN), according to an exemplary embodiment.

FIG. 7 is an illustration of a Controller Area Network (CAN), according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, systems and methods to provide OTA updates and telematic information via one more networks are described herein. For example, a refuse vehicle may include at least one of controllers, electronic control units, gateways, modules, data engines, edge devices, computing devices, and/or computing systems that can receive and/or transmit information. The controllers can communicate with a server, via one or more networks, to receive and/or transmit information. For example, the controllers may receive information from a network via a wireless network (e.g., Wi-Fi, LTE, 5G, etc.). The information may include software updates for the refuse vehicle and/or one or more components thereof. For example, the information may include an update to a dashboard interface that is displayed within a cabin of the vehicle. As another example, the information may include an update to one or more operations performed by a vehicle system of the vehicle. Stated otherwise, the controller can facilitate receipt and distribution of software updates, firmware changes, information presentment settings, or other operational changes to components of the refuse vehicle.

Various components of refuse vehicles may be clustered, organized, and/or otherwise arranged in one or more groups or networks. For example, a refuse vehicle may include a chassis network. To continue this example, the chassis network may include one or more components that form or relate to a chassis of the refuse vehicle (e.g., tractive elements, frames, support structures, suspension systems, etc.). The one or more components of the chassis network may produce and/or may be associated with telematic information. For example, activation of a brake system may produce telematic information. As another example, turning the refuse vehicle in a given direction may also produce telematic information.

Some technical solutions described herein include implementing a system that includes one or more primary controllers (e.g., modules, circuits, control units, etc.) to interface with and/or communicate with a server to receive and/or transmit information and one or more secondary controllers (e.g., modules, circuits, control units, etc.) to process and/or implement one or more actions associated with the information exchanged with the server. For example, a first controller may receive software updates associated with a given vehicle system of the refuse vehicle. To continue this example, the first controller may forward, transmit, and/or otherwise provide the software updates to a secondary controller that controls operation of the given vehicle system. In this example, upon review of the software updates, the secondary controller can update, adjust, finetune, or otherwise change operation of the given vehicle system by implementing the software updates.

In some instances, the controllers or modules may receive software updates from a server (which may be remote or connected via a local wireless network). The controller or modules may download the updates while the vehicle is performing its normal operations. Additionally, or alternatively, a gateway module (e.g., telematics module, a control module, etc.) may download the updates (when connected to power) to minimize downtime and thus ensuring continuous operation of the refuse vehicle. Stated otherwise, the gateway module may obtain, receive, collect, or otherwise receive updates while the refuse vehicle remains operational (e.g., turned on, moving, traveling, collecting refuse, etc.).

Furthermore, the modules of the refuse vehicle can communicate locally with other modules which ensures that the information (associated with the updates) is seamlessly shared or otherwise provided to subsequent modules. The local communication of the information (e.g., updates, firmware changes, software modifications, etc.) enhances the operational efficiency of the refuse vehicle. The ability for the modules to download and install updates (in the background), while the module receiving the update is not needed (for use by the refuse vehicle) further enhances the updating process. For example, the gateway module may, when the vehicle is off, download and install various software updates. As another example, when the gateway module is not needed (by the refuse vehicle), the gateway module may go offline (without affecting primary vehicle functionality) to download and install the various software updates.

In addition to software updates, the local exchange of information (between modules) can improve the distribution of diagnostic data logs. For example, operation of the refuse collection vehicle can result in the production and subsequent logging of telematic information (e.g., data logs). In instances where faults or other data occurrences are detected, one or more sets of diagnostic data logs may be produced. For example, the diagnostic data logs may include information from serialized communication networks like CAN, Ethernet, USB, and Wi-Fi, which provide comprehensive diagnostic data for analysis and maintenance. In some instances, the diagnostic data logs may be recorded and stored on the vehicle for a specified period before being uploaded to a remote server to ensure efficient data collection and transmission.

In some embodiments, the gateway module (which may be used to receive software updates) can further provide, publish, or other push diagnostic data logs for post-processing. The post-processing of data logs can occur either on the refuse vehicle (client-side) or on the server (server-side). In some embodiments, the diagnostic data logs can be initiated or halted based on various conditions, such as scheduled times, specific messages, elapsed time, remote prompts, and interactions with vehicle-mounted HMIs. This flexibility ensures that data collection is tailored to specific needs and operational scenarios.

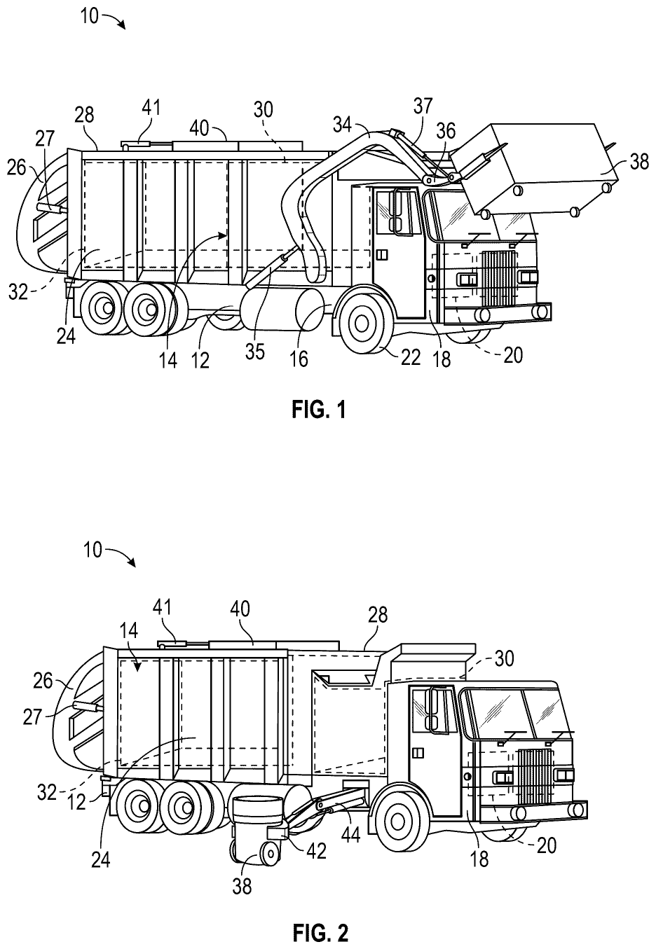

Referring to FIGS. 1-3, a vehicle (e.g., a refuse truck, a garbage truck, a waste collection truck, a sanitation truck, etc.), shown as refuse vehicle 10, includes a support structure (e.g., a frame or chassis), shown as frame 12, and a structural body or storage device, shown as body 14. The body 14 may be of various shapes, sizes, and configurations to accommodate different styles and variations of the refuse vehicle 10. The body 14 may have two generally lateral sides running substantially parallel from a front end of the body 14 to a back end of the body 14 (e.g., relative to a primary direction of travel of the refuse vehicle 10, etc.). The frame 12 is fixedly coupled to an occupancy compartment, shown as cab 18.

As shown in FIGS. 1-3, the cab 18 is coupled to a front end of the frame 12. The cab 18 includes various components to facilitate operation of the refuse vehicle 10 by an operator (e.g., a seat, a steering wheel, hydraulic controls, etc.). In one embodiment, the refuse vehicle 10 further includes a prime mover or primary driver, shown as engine 20, coupled to the frame 12 at a position beneath the cab 18. The engine 20 provides power to a plurality of motive members or tractive elements, shown as wheels 22, and to other systems of the vehicle (e.g., a pneumatic system, a hydraulic system, etc.). The engine 20 may be configured to utilize a variety of fuels (e.g., gasoline, diesel, biodiesel, ethanol, natural gas, etc.), according to various exemplary embodiments. According to an alternative embodiment, the engine 20 is replaced by or accompanied by one or more electric motors (e.g., in a hybrid configuration, in a pure electric configuration, etc.). The electric motors may consume electrical power from an on-board storage device (e.g., batteries, ultra-capacitors, etc.), from an on-board generator (e.g., an internal combustion engine, a thermoelectric generator, etc.), and/or from an external power source (e.g., overhead power lines, electromagnetic radiation, etc.) and provide power to the systems of the refuse vehicle 10.

According to an exemplary embodiment, the refuse vehicle 10 is configured to transport refuse from various waste receptacles within a municipality to a storage facility and/or a processing facility (e.g., a landfill, an incineration facility, a recycling facility, etc.). As shown in FIGS. 1-3, the body 14 includes panels 24, a tailgate 26, and a cover 28. The panels 24, the tailgate 26, and the cover 28 define a chamber that includes a collection chamber, shown as hopper portion 30, and a storage chamber, shown as storage portion 32. Loose refuse is placed into the hopper portion 30 and is thereafter compacted into the storage portion 32. The hopper portion 30 and the storage portion 32 provide temporary storage for refuse during transport to a waste disposal site and/or a recycling facility. In some embodiments, at least a portion of the body 14 extends in front of the cab 18. According to the embodiments shown in FIGS. 1-3, the body 14 is positioned behind the cab 18. According to an exemplary embodiment, the hopper portion 30 is positioned between the storage portion 32 and the cab 18 (i.e., refuse is initially loaded into a position behind the cab 18 and stored in a position further toward the rear of the refuse vehicle 10).

The tailgate 26 is pivotally coupled to the panels 24 such that the tailgate 26 is rotatable relative to the frame 12 about a lateral axis. A pair of actuators (e.g., hydraulic cylinders, pneumatic cylinders, linear actuators, etc.), shown as tailgate actuators 27, are coupled to the tailgate 26 and the panels 24. The tailgate actuators 27 are configured to selectively reposition the tailgate 26 between a lowered, packing, or closed position, shown in FIGS. 1 and 2, and a raised, emptying, or open position. In the closed position, the tailgate 26 extends across an opening defined by the panels 24, preventing refuse from exiting the body 14. In the open position, this opening is uncovered, permitting refuse to be evacuated from the body 14.

Referring again to the exemplary embodiment shown in FIG. 1, the refuse vehicle 10 is a front-loading refuse vehicle. As shown in FIG. 1, the refuse vehicle 10 includes manipulators, shown as a pair of arms 34, coupled to the frame 12 on either side of the cab 18. The arms 34 may be rotatably coupled to the frame 12 with a pivot (e.g., a lug, a shaft, etc.). A pair of lifting actuators (e.g., hydraulic cylinders, pneumatic cylinders, linear actuators, etc.), shown as arm lifting actuators 35, are coupled to the frame 12 and the arms 34, and extension of the arm lifting actuators 35 rotates the arms 34 about a lateral axis extending through the pivot. According to an exemplary embodiment, interface members or a container handling system, shown as forks 36, are coupled to the arms 34. The forks 36 may have a generally rectangular cross-sectional shape and are configured to engage a container, shown as the refuse container 38, (e.g., protrude through apertures within the refuse container 38, etc.). The forks 36 are pivotally coupled to the arms 34 such that forks 36 rotate relative to the arms 34 about a lateral axis to adjust an orientation of the refuse container 38. A pair of actuators (e.g., hydraulic cylinders, pneumatic cylinders, linear actuators, etc.), shown as fork actuators 37, are coupled to the arms 34 and the forks 36, and extension or retraction of the fork actuators 37 rotates the forks 36 about the lateral axis to control the orientation of the refuse container 38.

The refuse container 38 may be rectangular (e.g., an industrial refuse container, a commercial refuse container, a residential refuse container, a trash can, etc.), cylindrical (e.g., a residential refuse container, refuse bin, refuse can, a trash can, a ninety-six galleon refuse container, etc.), prismatic, or of any other shape for the storage of refuse, and may be thereby tailored for a target application. During operation of the refuse vehicle 10, the forks 36 are positioned to engage the refuse container 38 (e.g., the refuse vehicle 10 is driven into position until the forks 36 protrude through the apertures within the refuse container 38). As shown in FIG. 1, the arms 34 are rotated to lift the refuse container 38 over the cab 18. The fork actuators 37 articulate the forks 36 to tip the refuse out of the refuse container 38 and into hopper portion 30 through an opening in cover 28. The arm lifting actuators 35 and the fork actuators 37 thereafter rotate the arms 34 and the forks 36 to return the empty the refuse container 38 to the ground.

According to an exemplary embodiment, a top door 40 is slidably coupled to the body 14. An actuator (e.g., a hydraulic cylinder, a pneumatic cylinder, a linear actuator, etc.), shown as top door actuator 41, is coupled to the body 14 and the top door 40. The top door actuator 41 is configured to move the top door 40 longitudinally along a top surface of the body 14 (e.g., the cover 28) between an open or loading position and a closed, sealing, or driving position. In the loading position, the top door 40 is moved away from the opening to the hopper portion 30, permitting refuse to be added to the hopper portion 30. In the driving position, the top door 40 seals the opening, thereby preventing refuse from escaping the refuse vehicle 10 (e.g., due to wind, inertia, etc.).

Referring to the exemplary embodiment shown in FIG. 2, the refuse vehicle 10 is a side-loading refuse vehicle that includes a container handling system or manipulator, shown as grabber 42, configured to interface with (e.g., engage, wrap around, selectively couple to, etc.) the refuse container 38. According to the exemplary embodiment shown in FIG. 2, the grabber 42 is movably coupled to the body 14 with an arm 44. Together, the grabber 42 and the arm 44 may form a grabber assembly. The arm 44 includes a first end coupled to the body 14 and a second end coupled to the grabber 42. One or more actuators (e.g., hydraulic cylinders, pneumatic cylinders, linear actuators, etc.) articulate the arm 44 and position the grabber 42 to interface with the refuse container 38. The arm 44 may be moveable in one or more directions (e.g., up and down, left and right, in and out, rotation, etc.) to facilitate positioning the portion of the grabber 42 to interface with the refuse container 38.

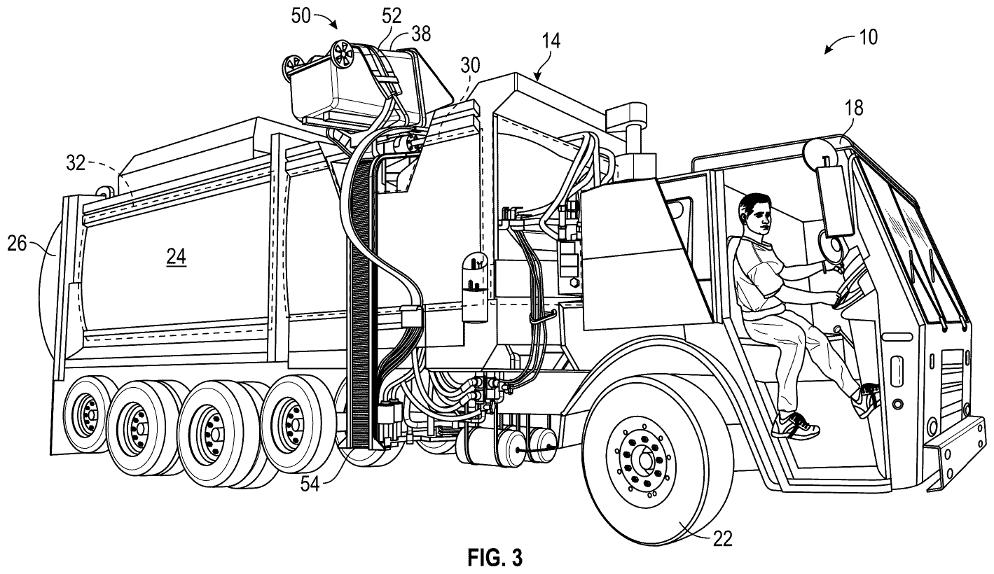

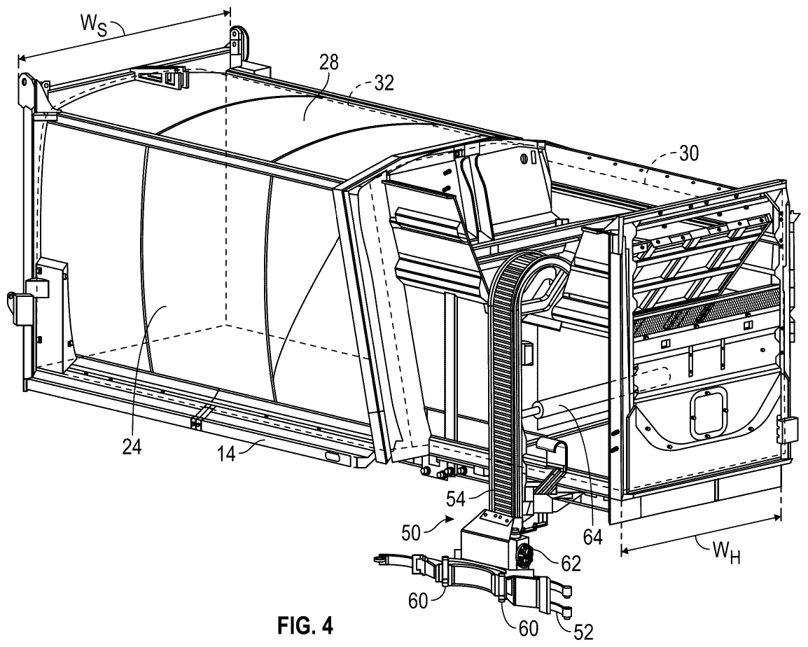

Referring to the exemplary embodiment shown in FIGS. 3-4, the refuse vehicle 10 is a zero-radius (e.g., ZR, etc.) side-loading refuse vehicle that includes a container handling system, shown as grabber assembly 50. The grabber assembly 50 includes a manipulator, shown as grabber 52, movably coupled to the body 14 with guide, shown as a track 54. The grabber 52 is opened and/or closed (e.g., to engage or release the refuse container 38) by one or more actuators (e.g., hydraulic cylinders, pneumatic cylinders, hydraulic motors, pneumatic motors, linear actuators, rotary actuators, etc.), shown as grabber actuators 60. The grabber 52 is moved along a length of the track by one or more actuators (e.g., hydraulic cylinders, pneumatic cylinders, hydraulic motors, pneumatic motors, linear actuators, rotary actuators, etc.), shown as grabber lift actuator 62. The grabber lift actuators 62 are coupled to the grabber 52 and the track 54.

The grabber 52 and the track 54 are translatably coupled to the body 14 (e.g., by a telescoping assembly). An actuator (e.g., hydraulic cylinders, pneumatic cylinders, linear actuators, etc.), shown as grabber extend actuator 64, is coupled to the track 54 and the body 14. The grabber extend actuator 64 is configured to extend and retract to move the grabber 52 and the track 54 laterally relative to the body 14. By way of example, the grabber extend actuator 64 may be extended to move the grabber 52 and the track 54 laterally outward from the body 14 to reach a refuse container 38 that is positioned a distance away from the body 14. As shown in FIG. 4, the body 14 includes a width W_{H} of the hopper portion 30 and a width W_{S} of the storage portion 30. Side-loading refuse vehicles such as that shown in FIGS. 3-4, the width W_{H} of the hopper portion 30 may be less than the width W_{S} of the storage portion 32 to accommodate the grabber assembly 50 without increasing an overall width of the refuse vehicle 10.

In operation, an operator drives the refuse vehicle 10 into position such that the grabber assembly 50 is longitudinally aligned with a refuse container 38. The grabber extend actuator 64 is then extended until the grabber 52 is proximate (e.g., in contact with, spaced a short distance from, etc.) the refuse container 38. The grabber actuator 60 is activated to close the grabber 52 on the refuse container 38. After interfacing with the refuse container 38, the grabber extend actuator 64 is retracted, and the grabber lift actuator 62 is activated to elevate the grabber 52 along the track 54. The track 54 may include a curved portion at an upper portion of the body 14 such that grabber 52 and the refuse container 38 are automatically tipped toward the hopper portion 30 of the refuse vehicle 10 when the grabber 52 reaches a predetermined position along the length of the track 54. As the grabber 52 is tipped, refuse falls through an opening defined by the cover 28 and into the hopper portion 30 of the refuse vehicle 10. The grabber lift actuator 62 and the grabber extend actuator 64 then return the empty refuse container 38 to its original position, and the grabber actuators 60 may release the refuse container 38. The top door 40 may be returned to the driving position to seal the opening, thereby preventing refuse from escaping the body 14 (e.g., due to wind, inertia, etc.).

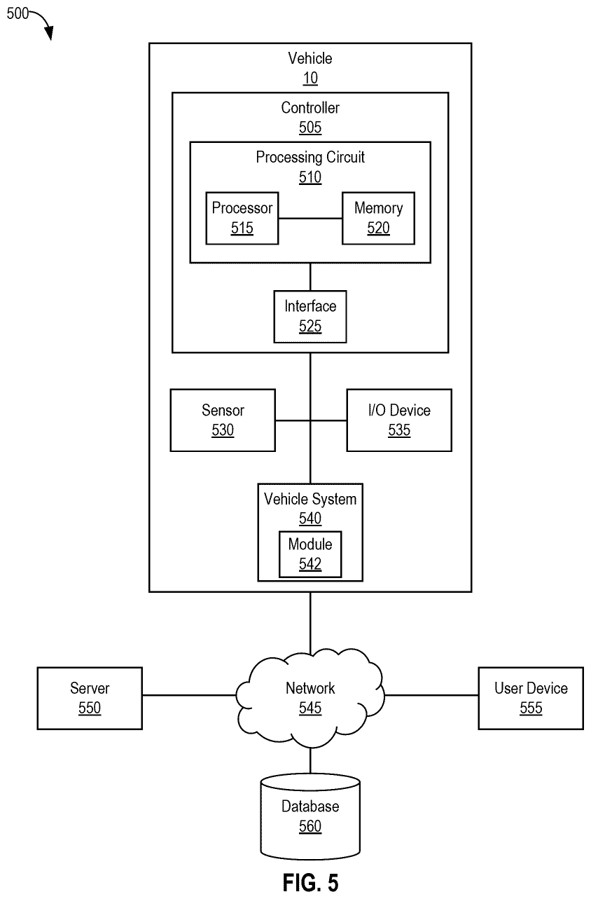

FIG. 5 depicts a block diagram of a system 500, according to an exemplary embodiment. In some embodiments, the system 500 can include the vehicle 10, at least one network 545, at least one server 550, and at least one database 560. The vehicle 10 may refer to and/or include at least one of the various vehicles described herein. For example, the vehicle 10 may include a refuse vehicle. In some embodiments, the vehicle 10 may include at least one controller 505, at least one sensor 530, at least one Input/Output device (shown as I/O device 535), and at least one vehicle system 540. For example, the controller 505 may be integrated with the vehicle 10. In some embodiments, the various components and/or devices of the vehicle 10 may be coupled with one another. For example, the controller 505 may be communicably coupled with the vehicle systems 540. The various components in the system 500 can be implemented via hardware (e.g., circuitry), software (e.g., executable code), or any combination thereof. Systems, devices, and components in FIG. 5 can be added, deleted, integrated, separated, and/or rearranged.

In some embodiments, the network 545 may include at least one of a local area network (LAN), wide area network (WAN), telephone network (such as the Public Switched Telephone Network (PSTN)), Controller Area Network (CAN), wireless link, intranet, the Internet, a cellular network, and/or combinations thereof. In some embodiments, the various systems, components, and/or devices included in the system 100 may communicate with one another via the network 545.

In some embodiments, the user device 555 may perform various actions and/or access various types of information. The information may be provided over the network 545. In some embodiments, the user device 555 may perform similar functionality to that of at least one system, device, and/or component of the system 500. For example, the user device 555 may perform similar operations to that of the controller 105. In some embodiments, the user device 555 may include one or more applications to receive information, display information, and/or receive user interactions with content displayed by the user device 55.

In some embodiments, the user device 555 may include at least one of a screen, a monitor, a visual display device, a touchscreen display, a television, a video display, a liquid crystal display (LCD), a light emitting diode (LED) display, a mobile device, a kiosk, a digital terminal, a mobile computing device, a desktop computer, a smartphone, a tablet, a smart watch, a smart sensor, and/or any other device that can facilitate providing, receiving, displaying and/or otherwise interacting with content (e.g., webpages, mobile applications, etc.). For example, the user device 555 may include displays that include a resistive touchscreen that can receive user input via interactions (e.g., touches) with the touchscreen.

In some embodiments, the server 550 may include at least one of a computing device, a remote server, a server bank, a remote device, and/or among other possible computer hardware and/or computer software. For example, the server 550 may include a server bank and the server bank can store, keep, maintain, and/or otherwise hold the various types of information described herein. In some embodiments, the server 550 may house and/or otherwise implement at least one of the various systems, devices, and/or components described herein. In some implementations, the controller 505 and/or various other components of the system 500 may be implemented using cloud computing services/platforms.

In some embodiments, the sensors 530 may include at least one of a position sensor, an accelerometer, a tachometer, a speedometer, a GPS device/sensor, a temperature sensor, a voltmeter, an ammeter, a radar sensor, a pressure sensor, a tactile sensor, a photodetector, a motion sensor, a proximity sensor, a telemetry device, and/or among other possible sensors and/or devices. For example, the sensors 530 can include a position sensor that can collect data to determine a position and/or an orientation of the vehicle 10. In other embodiments, the sensors 530 may include cameras, video devices, audio devices, haptic devices, optical devices, and/or other possible optical instruments can capture, record, produce and/or otherwise provide videos and/or images. The cameras can also include audio devices. For example, the cameras can include at least one of a speaker, a microphone, a headphone, and/or among other possible audio and/or sound devices.

In some embodiments, the sensors 530 may be placed, located, situated, positioned, coupled, and/or otherwise disposed on various components and/or locations on the vehicle 10. In some embodiments, the sensors 530 may collect the various types of data and/or information described herein. For example, the sensors 530 may collect telemetry data, diagnostics data, vehicle operation data, and/or data inputs. In some embodiments, the telemetry data may include data relating to the operation of the vehicle 10 such as, system statuses, a status of various vehicle subsystems and components (e.g., engine, transmission, tire pressure, brakes, pump(s), etc.), vehicle status (e.g., if a door is open, if equipment is deployed, etc.), and/or implement actions.

In some embodiments, the I/O devices 535 may be or include a steering wheel, a joystick, buttons, switches, knobs, levers, an accelerator pedal, a brake pedal, etc. In some embodiments, the I/O devices 535 may include at least one of a screen, a monitor, a visual display device, a touchscreen display, a television, a video display, a light emitting diode (LED) display, a mobile device, a kiosk, a digital terminal, a mobile computing device, a desktop computer, a smartphone, a tablet, a smart watch, a smart sensor, and/or any other device that can facilitate providing, receiving, displaying and/or otherwise interacting with content (e.g., webpages, mobile applications, etc.). For example, the I/O devices 535 may include displays that include a resistive touchscreen that can receive user input via interactions (e.g., touches) with the touchscreen.

In some embodiments, the I/O devices 535 may receive at least one input. For example, I/O device 535 may include a joystick and the I/O device 535 may receive an input responsive to movement (e.g., interaction) of the joystick by an operator of the vehicle 10. In some embodiments, the I/O devices 535 may receive inputs to control the vehicle systems 540. For example, movement of the I/O devices 535 may cause various control signals to be transmitted to a hydraulic system of the vehicle 10 that causes the hydraulic system to provide fluid power to the vehicle systems 540.

In some embodiments, the vehicle systems 540 may include at least one of the various systems, assemblies, apparatuses, components, and/or various elements of the vehicle 10 described herein. For example, the vehicle systems 540 may include the arms 34. As another example, the vehicle systems 540 may include the tailgate actuators 27. As even another example, the vehicle systems 540 may include one or more movable and/or translatable components of the vehicle 10. In some embodiments, the vehicle systems 540 may perform at least one operation of the vehicle 10. For example, the arms 34 (e.g., a first vehicle system 540) may lift and/or move refuse container (e.g., a first operation). As another example, the grabber 52 (e.g., a second vehicle system 540) may grab the refuse container (e.g., a second operation). As another example, the engine 20 (e.g., a third vehicle system 540) may provide power to one or more tractive elements to cause the vehicle 10 to move (e.g., along a path, on a road, on a ground surface, etc.). In some embodiments, operations of the vehicle 10 may refer to and/or include the vehicle systems 540 performing one or more actions, functions, routines, and/or movements as described herein.

In some embodiments, the controller 505 may include at least one processing circuit 510 and at least one interface 525. The controller 505 may be communicably coupled with at least one or more component of the system 500 via the interface 525. In some embodiments, the processing circuit 510 may include at least one processor 515 and memory 520. In some embodiments, the processing circuits 510 and/or one or more components thereof (e.g., the processors 515 and memory 520) may perform similar functionality to that of the controller 505, and/or one or more components thereof. For example, memory 520 may store programming logic that, when executed by the processors 515, cause the processors 515 to collect one or more data logs. In some embodiments, the processors 515 may be implemented as a general-purpose processor, an application specific integrated circuit (ASIC), one or more field programmable gate arrays (FPGAs), a group of processing components, or other suitable electronic processing components.

In some embodiments, memory 520 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 520 may be or include volatile memory or non-volatile memory. Memory 520 may include database components, object code components, script components, or any other type of information structure for supporting the various activities and information structures described in the present application. According to an exemplary embodiment, memory 520 is communicably connected to the processors 515 via the processing circuits 510 and memory 520 includes computer code for executing (e.g., by the processing circuits 510 and/or the processors 515) one or more processes described herein.

In some embodiments, the interface 525 may include at least one of network communication devices, network interfaces, and/or other possible communication interfaces. The interface 525 may include wired or wireless communications interfaces (e.g., jacks, antennas, transmitters, receivers, transceivers, wire terminals, etc.) for conducting data communications with various systems, devices, and/or components described herein. The interface 525 may be direct (e.g., local wired or wireless communications) and/or via a communications network. For example, the interface 525 may include an Ethernet card and port for sending and receiving data via an Ethernet-based communications link or network. The interface 525 may also include a Wi-Fi transceiver for communicating via a wireless communications network. The interface 525 may include a power line communications interface. The interface 525 may include an Ethernet interface, a USB interface, a serial communications interface, and/or a parallel communications interface.

In some embodiments, the database 560 may include and/or represent various forms for memory and/or data structures to store information. For example, the database 560 may include components or devices similar to that of memory 520. In some embodiments, the database 560 may refer to and/or include a collection of information that is stored and/or maintain in one or more data structures. In some embodiments, one or more systems, devices, and/or components of the system 500 may store information in the database 560. For example, the controller 505 may store data logs in the database 560.

In some embodiments, the vehicle systems 540 may include at least one module 542. The modules 542 may refer to and/or include at least one of controllers, electronic control units, data logic units, gateways, edge devices, computing devices, and/or various other possible processing circuits and/or processing devices. Additionally, and/or alternatively the modules 542 may refer to or include circuitry housed or otherwise contained within a standalone unit. For example, the modules 542 may include a printed circuit board (PCB) which houses components (of the modules 542) such as, programmable logic controllers (PLC), integrated circuits, connectors, power supplies, Input/Output components (e.g., GPIO pins, PCIe pins, etc.), communication devices, execution hardware (e.g., graphic cards, Graphic Processing Units (GPUs), Central Processing Units (CPUs), etc.), or other possible circuitry to provide given functionality. In some embodiments, the modules 542 may refer to or include secondary controllers. For example, the modules 542 may control operation of their corresponding vehicle system 540. As another example, the modules 542 may forward various signals to corresponding components of the vehicle systems 540.

In some embodiments, the modules 542 may include at least one module 542 that can communicate via a wireless network. For example, the modules 542 may communicate via a wireless network (Wi-Fi, LTE, 5G, etc.). As another example, the modules 542 may communicate via the network 545 and/or a localized network, such as a CAN. In some embodiments, the modules 542 may transmit one or more sets of information. For example, a first module 542 may transmit or upload diagnostic data (e.g., data logs, telematic information, operation information, etc.) to the server 550. In some embodiments, the diagnostic data may refer to or include information associated with a serialized communication network (e.g., CAN, Ethernet, USB, Wi-Fi, etc.). In some embodiments, the controller 505 may perform operations similar to the modules 542. For example, the controller 505 may transmit data logs to the server 550. As another example, the controller 505 may establish communication with or otherwise communicate with the server 550. As another example, the controller 505 may receive, obtain, collect, or otherwise accept software updates transmitted by the server 550.

In some embodiments, the modules 542 may communicate in accordance with one or more protocols or network standards. For example, the modules 542 may communicate via a wireless communication protocol (e.g., Wi-Fi, LTE, 5G, etc.). As another example, the modules 542 may communicate via a local communication protocol (e.g., Local Area Network, Controller Area Network, Personal Area Network, etc.). Stated otherwise, the modules 542 may communicate in accordance with one or more discrete or separate communication networks, protocols, or systems.

In some embodiments, the server 550 may store one or more sets of information. For example, the server 550 may store software updates associated with the vehicle 10. As another example, the server 550 may store data logs associated with the vehicle 10. In some embodiments, the controller 505 may receive one or more sets of information from the server 550. For example, the controller 505 may receive software updates from the server 550. As another example, the server 550 may transmit the software updates via one or more over the air (OTA) updates. In some embodiments, the software updates may be associated with the vehicle systems 540 and/or operations of the vehicle 10. For example, the software updates may pertain to operational changes to an actuator of the vehicle 10. As another example, the software updates may specify, identify, and/or indicate given telematics information to collect for a given vehicle system 540.

In some embodiments, the controller 505 may transmit the updates to the module 542. For example, the controller 505 and the modules 542 may be coupled with one another via a CAN. To continue this example, the controller 505 may transmit the updates to the modules via the CAN. In some embodiments, the controller 505 may transmit the updates to a given module 542. For example, a given software update may be associated with a chassis (e.g., a given vehicle system 540). To continue this example, the controller 505 may transmit the given software update to a module 542 that is associated with the chassis.

In some embodiments, the controller 505 may transmit one or more updates based on a status of a corresponding component, vehicle system, vehicle device, or element of the vehicle 10. For example, upon receipt of a software element for display device of the vehicle 10, the controller 505 may monitor a status (on, off, presenting information, etc.) of the display device to detect one or more points in time to deliver the software update. The controller 505 may push or publish (via a data bus) the software update to the display device or a corresponding module 542, responsive to the display device having an off state or otherwise idle state (e.g., absence or otherwise not performing one or more actions or operations). As another example, the controller 505 may identify (based on information included in the software updates) one or more updates that may be pushed or provided immediately to corresponding components of the vehicle 10. Stated otherwise, the controller 505 may identify software updates to push regardless of a current status or operation of the corresponding component.

In some embodiments, the controller 505 may publish or otherwise provide software updates according to a priority level or type of operation performed by the vehicle systems 540. For example, a first vehicle system 540 that is associated with operations to collect refuse may include a first priority level and a second vehicle system 540 that stabilizes or maintains position of the vehicle 10 may include a second priority level. In some embodiments, the controller 505 may prioritize publishing of software updates to the second vehicle system 540 given that second vehicle system 540 has the second priority level. As another example, the software updates may include information to indicate one or more updates (included in the software updates) for which to prioritize in publication. Stated otherwise, the controller 505 may publish or provide one or more software updates in accordance with tags or labels that indicate an order for which the software updates be published.

In some embodiments, the controller 505 may omit, refrain, or otherwise prevent the transmission of one or more software updates. For example, the controller 505 may prevent (e.g., not transmit) one or more software updates from being provided to an active or operational component. As another example, if a given module 542 is performing an operation (e.g., controller a given vehicle system 540), the controller 505 may prevent the transmission of the software updates which otherwise (upon receipt) would trigger the module 542 to download and implement the software updates. Stated otherwise, even if software updates may be received, the controller 505 may refrain or selectively transmit software updates based on an operational status of given modules (e.g., the modules 542).

In some embodiments, the controller 505 may identify given software updates that pertain to given modules. For example, the software updates may include information to indicate or otherwise identify which software updates pertain to which module. As another example, the software updates may include tags or flags to identify a corresponding module 542. In some embodiments, upon identification of a software update (e.g., a determination that the software updates pertains to a corresponding module), the controller 505 may transmit or prevent a transmission of the software update based on a status of the corresponding module 542.

In some embodiments, the controller 505 may store one or more sets of information. For example, the controller 505 may store diagnostic information in the database 560. As another example, the controller 505 may store information collected by the sensors 530 in the database 560. In some embodiments, the controller 505 may store data logs (e.g., sets of information, diagnostic information, etc.) based one or more rules. For example, the controller 505 may store data logs for a given amount of time prior to transmitting the data logs to the server 550.

In some embodiments, the controller 505 may store data logs specific to the vehicle 10 and/or the vehicle systems 540. For example, the controller 505 may store a data log(s) for the entirety of a requested period of time for the vehicle 10 before uploading the data log(s) to the server 550. As another example, the controller 505 may store data logs specific to a given vehicle system 540 of the vehicle 10. In some embodiments, the controller 505 may cache the data logs and then subsequently transmit the data logs to the server 550 at one or more time increments (e.g., in discrete increments over a period of time and uploaded continuously, etc.). For example, the controller 505 may transmit the data logs every 15 minutes. As another example, the controller 505 may transmit the data logs continuously and/or sequentially.

In some embodiments, the controller 505 may receive the data logs post processing. For example, the controller 505 may receive the data logs responsive to a module 542 converting a hex message to decimal values. As another example, the controller 505 may receive the data logs responsive to transmission of a diagnostic message. In some embodiments, the server 550 may process and/or collect the data logs described herein. For example, the server 550 may implement post processing of the data logs. In some embodiments, the data logs may include information, such as, High Voltage (HV) component status, hydraulic component status, proximity switch status, ground speed, engine RPM, keypad presses, autonomous commands, joystick commands, and/or valve position.

In some embodiments, the controller 505 may initiate and/or halt the collection of data logs based on various conditions (e.g., rules), such as operating conditions, scheduled times, start/end points on specific messages (e.g., a script), after an elapsed time exceeding a threshold (e.g., 1 minute, 3 minutes, 5 minutes, etc.), instantaneous responsive to start/end points from a remote prompt, instantaneous start/end times from a Human-Machine Interface, etc. For example, the controller 505 may collect data logs at one or more scheduled points in time. As another example, the controller 505 may collect data logs responsive to receiving one or more messages. As even another example, the controller 505 may halt the collection of data logs responsive to a given amount of time elapsing or passing. As even another example, the controller 505 may collect data logs based on interactions with a Human-Machine Interface (e.g., the I/O device 535). In this example, the controller 505 may start the collection of the data logs based on a first interaction and the controller 505 may halt the collection of the data logs based on a second interactions.

In some embodiments, the data logs (e.g., information collected and/or obtained by the controller 505) may refer to or include multiple networks. For example, a first data log may pertain to a chassis network (e.g., a given vehicle system 540). As another example, a first data log may pertain to the tailgate actuators 27. In some embodiments, the modules 542 may collect and/or check for the data logs. For example, a given module 542 may collection information produced and/or obtained by the sensors 530. As another example, the given module 542 may collection information while a corresponding vehicle system 540 is operating and/or otherwise producing information.

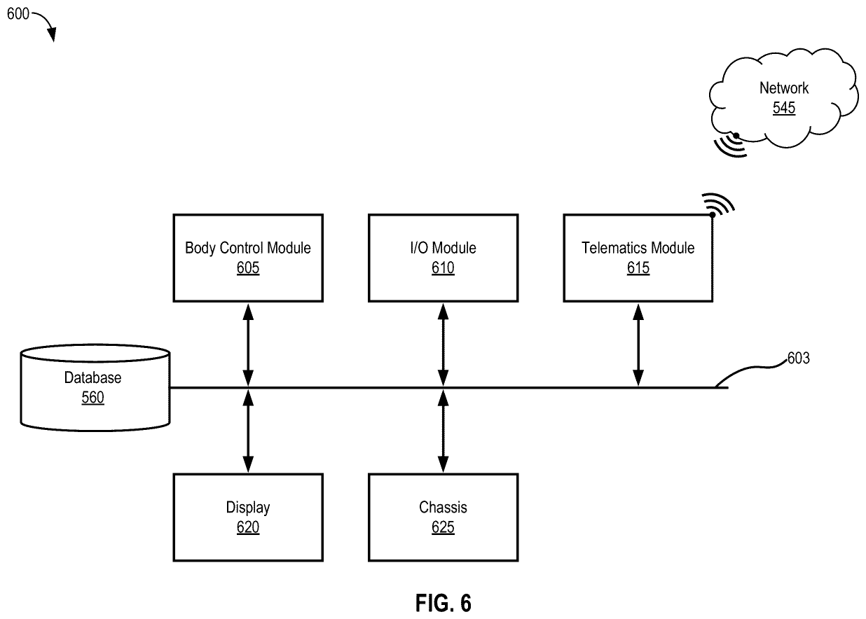

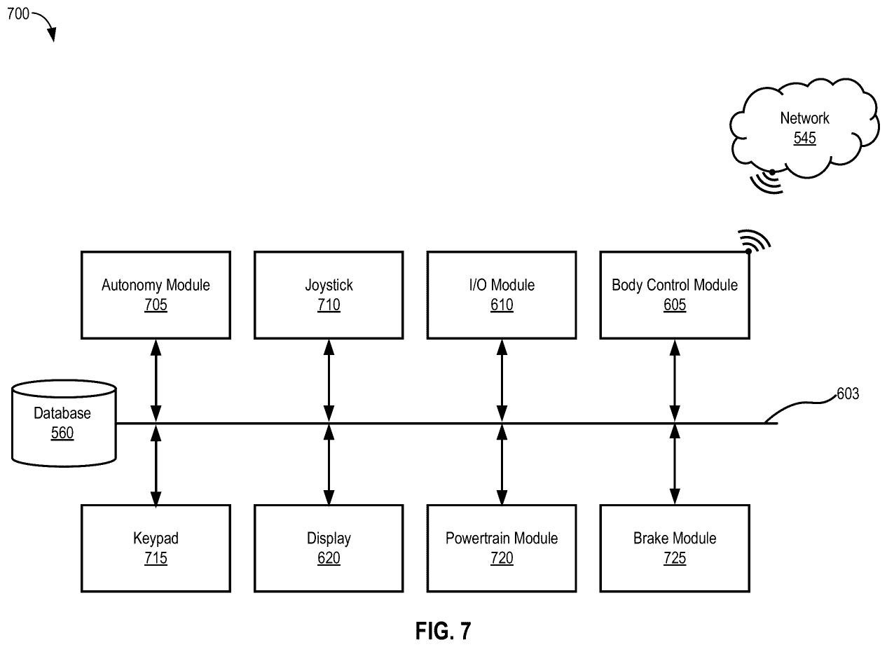

FIGS. 6-7 illustrate example Controller Area Networks. For example, as shown in FIG. 6, a Controller Area Network (CAN) 600 may include at least one bus 603. In some embodiments, one or modules may be coupled with one another via the bus 603. For example, as shown in FIG. 6, a body control module 605, an I/O module 610, a telematics module 615, a display 620, a chassis 625, and the database 560 are shown to be coupled with one another via the bus 603. As another example, as shown in FIG. 7, a CAN 700 may include an autonomy module 705, a joystick 710, the I/O module 610, the body control module 605, a keypad 715, the display 620, a powertrain module 20, a brake module 725, and the database 560 that are coupled with one another via the bus 603. In some embodiments, the modules (illustrated in FIG. 6 and/or FIG. 7) may refer to and/or include the various modules described herein. For example, the body control module 605 may include the modules 542.

In some embodiments, at least one of the modules illustrated in FIG. 6 and/or FIG. 7 may communicate via one or more networks. For example, as shown in FIG. 6, the telematics module 615 may communicate via the network 545. To continue this example, the telematics module 615 may communicate with the server 550 via the network 545. As another example, as shown in FIG. 7, the body control module 605 may communicate with the server 550 via the network 545. In some embodiments, the CAN 600, the CAN 700, and/or one or more components (e.g., modules) may receive one or more software updates via the network 545. For example, the network 545 may forward or otherwise provide (to the CAN 600, the CAN 700, etc.) one or more software updates transmitted by the server 550. In some embodiments, the controller 505 may refer to or include modules that communicate via the network 545. For example, the controller 505 may include the body control module 605.

In some embodiments, the controller 505 and/or one or more modules thereof may transmit software updates to the various modules, systems, networks, and/or devices of the CAN 600 and/or the CAN 700. For example, the controller 505 may locally communicate one or more software updates, to the I/O module 610, via the bus 603. As another example, the controller 505 may store one or more data logs, in the database 560, by transmitting one or more signals to the database 560 via the bus 603. As another example, the controller 505 may publish or otherwise push one or more software updates (to the bus 603) with information to indicate or identify a corresponding module (e.g., a module for which the software updates pertain to).

In some embodiments, the controller 505 may receive one or more software updates as a package (e.g., a data packet, a data transmission, etc.). The controller 505 may download the package while the vehicle 10 is performing normal operations (e.g., turned on, moving, collecting refuse, etc.). The controller 505 may also download the package while at least one of the modules described herein has power. As another example, the controller 505 may download the package during normal operation of the vehicle 10. Stated otherwise, at least one component (e.g., vehicle systems 540, actuators, grabbers, etc.) may remain active or operational while the controller 505 downloads the package. In some embodiments, the controller 505 may download the package while the vehicle 10 is off (e.g., overnight, idle, etc.). For example, the controller 505 may download the package responsive to the vehicle 10 having been turned off or idle for a given amount of time. As another example, the controller 505 may download the package at one or more scheduled points in time.

In some embodiments, the modules in communication with the network 545 may listen for information (e.g., check, prompt, search, etc.) at one or more predetermined points in time. For example, the body control module 605 may check for software updates at a given time during the day. In some embodiments, the modules in communication with the network 545 may collect information associated with given messages and/or packages. For example, the body control module 605 may only collect information associated with a given vehicle system 540. As another example, the body control module 605 may only collect information, from the server 550, that has a data size (e.g., an amount of information) that is below one or more thresholds.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A refuse vehicle, comprising:
a first vehicle system configured to perform one or more first operations of the refuse vehicle, wherein the first vehicle system is controllable by a first controller;
a second vehicle system configured to perform one or more second operations of the refuse vehicle, wherein the second vehicle system is controllable by a second controller; and
a third controller, comprising:
one or more processing circuits configured to:
receive, during operation of the refuse vehicle, from a server via a network, a plurality of updates associated with at least one of the first vehicle system, the second vehicle system, the one or more first operations, or the one or more second operations;
determine, based on information included with at least one update of the plurality of updates, that the at least one update corresponds to the second vehicle system; and
transmit, during the operation of the refuse vehicle, via a Controller Area Network (CAN) bus, the at least one update to the second controller based on a status of the second vehicle system.

2. The refuse vehicle of claim 1, wherein the operation of the refuse vehicle includes a performance of the one or more first operations, and further comprising:
the one or more processing circuits configured to:
detect, responsive to receipt of the plurality of updates, the performance of the one or more first operations;
identify, based on information included with the plurality of updates, at least one second update of the plurality of updates that pertains to the first controller; and
prevent, responsive to identification of the at least one second update, a transmission of the at least one second update to the first controller to maintain operation of the first controller.

3. The refuse vehicle of claim 1, further comprising:
the one or more processing circuits configured to:
identify, based on information included with the plurality of updates, one or more tags which indicate an order for which to provide one or more second updates of the plurality of updates; and
transmit, via the CAN bus, the one or more second updates according to the order.

4. The refuse vehicle of claim 1, further comprising:
the third controller configured to:
establish communication with the server via the network; and
control performance of one or more third operations by at least one third vehicle system of the refuse vehicle.

5. The refuse vehicle of claim 1, further comprising:
the first vehicle system including at least one of:
a chassis;
one or more tractive elements;
a powertrain;
a primary mover;
a braking system; or
a hydraulic system; and
the second vehicle system including at least one of:
a display device;
a joystick;
one or more tactile elements;
a keypad; or
an audio device.

6. The refuse vehicle of claim 1, further comprising:
the one or more processing circuits configured to:
receive, via the CAN bus, diagnostic information associated with the first vehicle system;
store, based on one or more rules, the diagnostic information in a database stored in memory of the third controller; and
transmit, responsive to an amount of elapsed time exceeding a threshold, the diagnostic information to the server via the network.

7. The refuse vehicle of claim 1, further comprising:
the one or more processing circuits configured to:
transmit, subsequent to one or more predetermined points in time, telematics information to the server via the network, wherein the telematics information is associated with a performance of the one or more first operations or a performance of the one or more second operations.

8. The refuse vehicle of claim 1, wherein a performance of the one or more first operations results in the refuse vehicle moving along a path, and wherein a performance of the one or more second operations results in a collection of at least one refuse container.

9. The refuse vehicle of claim 1, wherein the server is configured to transmit the plurality of updates to the third controller via one or more over-the-air (OTA) updates.

10. The refuse vehicle of claim 1, wherein the status of the second vehicle system includes an absence of a performance of the one or more second operations.

11. A system, comprising:
a first controller configured to control a first vehicle system of a refuse vehicle, the first vehicle system configured to perform one or more first operations of the refuse vehicle;
a second controller configured to control a second vehicle system of the refuse vehicle, the second vehicle system configured to perform one or more second operations of the refuse vehicle; and
a third controller, comprising:
one or more processing circuits configured to:
receive, from a server via a network, a plurality of updates associated with at least one of the first vehicle system, the second vehicle system, the one or more first operations, or the one or more second operations;
detect, responsive to receipt of the plurality of updates, a performance of the one or more first operations;
prevent, responsive to detection of the performance of the one or more first operations, a transmission of at least one first update of the plurality of updates to the first controller to maintain operation of the first controller; and
transmit, to the second controller via a Controller Area Network (CAN) bus, at least one second update of the plurality of updates based on the second vehicle system being in an idle state.

12. The system of claim 11, further comprising:
the one or more processing circuits configured to:
determine, based on information included with the at least one second update, that the at least one second update corresponds to the second vehicle system; and
transmit, via the CAN bus, the at least one second update to the second controller.

13. The system of claim 11, further comprising:
the one or more processing circuits configured to:
identify one or more tags which indicate an order for which to provide one or more third updates of the plurality of updates; and
transmit, via the CAN bus, the one or more third updates according to the order.

14. The system of claim 11, further comprising:
the third controller configured to:
establish communication with the server via the network; and
control performance of one or more third operations by at least one third vehicle system of the refuse vehicle.

15. The system of claim 11, further comprising:
the first vehicle system including at least one of:
a chassis;
one or more tractive elements;
a powertrain;
a primary mover;
a braking system; or
a hydraulic system; and
the second vehicle system including at least one of:
a display device;
a joystick;
one or more tactile elements;
a keypad; or
an audio device.

16. A system, comprising:
a refuse vehicle, including:
a vehicle system configured to perform one or more operations of the refuse vehicle; and
a first controller, comprising:
one or more processing circuits configured to:
receive, from a server via a network, a plurality of updates associated with the vehicle system or the one or more operations of the refuse vehicle; and
transmit, via a controller area network (CAN) bus, the plurality of updates to a second controller configured to control performance of the one or more operations.

17. The system of claim 16, further comprising:
the one or more processing circuits configured to:
receive at least one update of the plurality of updates during operation of the refuse vehicle, wherein the operation of the refuse vehicle includes a performance of one or more second operations by a second vehicle system of the refuse vehicle;
determine, based on information included with the at least one update, that the at least one update corresponds to the vehicle system; and
transmit, via the CAN bus, the at least one update to the second controller based on a status of the vehicle system.

18. The system of claim 16, further comprising:
the one or more processing circuits configured to:
identify, based on information included with the plurality of updates, one or more tags which indicate an order for which to provide each update of the plurality of updates; and
transmit, according to the order, via the CAN bus, respective updates of the plurality of updates to the second controller.

19. The system of claim 16, further comprising:
the one or more processing circuits configured to:
detect, responsive to receipt of the plurality of updates, the performance of the one or more operations;
prevent, responsive to detection of the performance of the one or more operations, a transmission of the plurality of updates to the second controller; and
transmit, responsive to completion of the performance of the one or more operations, the plurality of updates to the second controller.

20. The system of claim 16, further comprising:
the first controller configured to:
control performance of one or more second operations by at least one second vehicle system of the refuse vehicle.
